(19) United States
(12) Patent Application Publication
(10) Pub. No.: US 2026/0291397 A1
(43) Pub. Date: Sep. 24, 2026

(54) POWER CONVERSION DEVICE

(71) Applicant: Astemo, Ltd., Chiyoda-ku, Tokyo (JP)

(72) Inventors: Yoshihito YASUKAWA, Hitachinaka-shi, Ibaraki (JP); Toshiyuki INNAMI, Hitachinaka-shi, Ibaraki (JP); Hideki MIYAZAKI, Hitachinaka-shi, Ibaraki (JP); Tomoya FUNABASHI, Hitachinaka-shi, Ibaraki (JP); Yuta KOIKE, Hitachinaka-shi, Ibaraki (JP); Takae SHIMADA, Tokyo (JP); Yoshinori KURIMOTO, Tokyo (JP); Tomoki SAKABE, Tokyo (JP)

(73) Assignee: Astemo, Ltd., Chiyoda-ku, Tokyo (JP)

(21) Appl. No.: 19/473,062

(22) PCT Filed: Apr. 10, 2023
(86) PCT No.: PCT/JP2023/014541

§ 371 Date: Oct. 6, 2025

(51) Int. Cl. H02M 3/335; B60L 53/20; B60L 58/18; H02J 7/02; H02J 7/34; H02M 1/00; H02M 7/5387

(52) U.S. Cl. CPC H02M 3/33573; B60L 53/20; B60L 58/18; H02J 7/02; H02J 7/342; H02M 1/0074; H02M 7/5387; B60L 2210/20; B60L 2210/30; B60L 2210/40; H02J 2207/20; H02M 1/0043

(57) ABSTRACT

A power conversion device that can be shared by batteries having different output voltages is disclosed. This power conversion device converts an output voltage of a battery into an AC voltage or a DC voltage lower in voltage than the output voltage of the battery, and includes a multi-winding transformer (1), and a first DC/AC converter (11) and a second DC/AC converter (12) whose DC sides are connected to the battery. In a case where the output voltage of the battery is larger than a withstand voltage of semiconductor switching elements, respective DC inputs of the first DC/AC converter (11) and the second DC/AC converter (12) are connected in series to each other. In a case where the output voltage of the battery is smaller than the withstand voltage, the respective DC inputs of the first DC/AC converter (11) and the second DC/AC converter (12) are connected in parallel to each other, or only one of the DC inputs of the first DC/AC converter (11) and the DC inputs of the second DC/AC converter (12) is connected to the battery.

### TECHNICAL FIELD

The present invention relates to a power conversion device that converts DC power of a power storage device via a transformer into DC power or AC power having a voltage lower than an output voltage of the power storage device.

### BACKGROUND ART

An electric moving body such as an electric vehicle includes an electric motor drive system including an electric motor, a power storage device such as a battery having a relatively high voltage (for example, several 100 V or more), and a power conversion device that converts output power of the power storage device into desired power and drives the electric motor with the converted power.

The electric moving body includes a low-voltage power storage device for electric equipment to be mounted, and a commercial AC voltage output unit for equipment that operates at a commercial AC voltage. Therefore, an output voltage of the high-voltage electric storage device for driving the electric motor is stepped down using the power conversion device.

As a prior art related to such a power conversion device, a technique described in PTL 1 is known.

In the present prior art, a multi-winding transformer is applied. A high-voltage (for example, 350 V to 500 V) main battery is connected to a first winding of the multi-winding transformer via an inverter circuit. An AC voltage output from the inverter circuit is stepped down by the multi-winding transformer, and the stepped-down AC voltage is output from a second winding and a third winding of the multi-winding transformer.

The AC voltage output from the second winding is converted into a commercial AC voltage by a rectifier circuit and the inverter circuit. This commercial AC voltage is output from an AC output terminal. The AC voltage output from the third winding is converted into a DC voltage by the rectifier circuit. An auxiliary battery is charged by the DC voltage.

According to the present prior art, an installation space for the power conversion device that converts a DC voltage of a main battery into a low-voltage DC voltage and AC voltage is reduced.

### CITATION LIST

### Patent Literature

PTL 1: JP 2008-109754 A

### SUMMARY OF INVENTION

### Technical Problem

In recent years, in order to increase a capacity of a main battery and shorten a charging time, an increase in voltage of the main battery has been promoted. For this reason, a standard main battery and a main battery having a high voltage can be selectively used for each type and application of the system. In this situation, according to the above-described prior art, it is necessary to use a plurality of types of power conversion devices having different withstand voltages of the inverter circuits connected to the main battery.

Therefore, the present invention provides a power conversion device that can be shared by main batteries having different output voltages.

### Solution to Problem

In order to solve the above problem, a power conversion device according to the present invention converts an output voltage of a battery into an AC voltage or a DC voltage lower in voltage than the output voltage of the battery, the power conversion device including: a multi-winding transformer including a plurality of windings, the plurality of windings including a first primary-side winding, a second primary-side winding, and a secondary-side winding; a first DC/AC converter having a DC side and an AC side connected to the battery and the first primary-side winding, respectively; a second DC/AC converter having a DC side and an AC side connected to the battery and the second primary-side winding, respectively; and a power converter that converts an AC voltage output from the secondary-side winding into an AC voltage or a DC voltage lower in voltage than an output voltage of the battery. In a case where an output voltage of the battery is larger than a withstand voltage of a plurality of semiconductor switching elements in the first DC/AC converter and the second DC/AC converter, respective DC inputs of the first DC/AC converter and the second DC/AC converter are connected in series to each other, and both ends of the DC inputs connected in series are connected to the battery. In a case where the output voltage of the battery is smaller than the withstand voltage, the respective DC inputs of the first DC/AC converter and the second DC/AC converter are connected in parallel to each other, and both ends of the DC inputs connected in parallel are connected to the battery, or only one of the DC inputs of the first DC/AC converter and the DC inputs of the second DC/AC converter is connected to the battery.

ADVANTAGEOUS EFFECTS OF INVENTION

The power conversion device according to the present invention can be shared by main batteries having different output voltages.

Problems, configurations, and effects other than those described above will be clarified by the following description of embodiments.

### BRIEF DESCRIPTION OF DRAWINGS

FIG. 1 is a circuit diagram illustrating a configuration of a power conversion device that is Example 1.

FIG. 2 is a circuit diagram illustrating a first connection form of a main battery on a DC side of a DC/AC conversion circuit.

FIG. 3 is a circuit diagram illustrating a second connection form of the main battery on the DC side of the DC/AC conversion circuit.

FIG. 4 is a circuit diagram illustrating a third connection form of the main battery on the DC side of the DC/AC conversion circuit.

FIG. 5 is a circuit diagram illustrating a fourth connection form of the main battery on the DC side of the DC/AC conversion circuit.

FIG. 6 is a circuit diagram illustrating a configuration of a power conversion device that is Example 2.

FIG. 7 is a flowchart illustrating an operation of a control unit in Example 2.

FIG. 8 is a timing chart illustrating on/off of a drive signal generated by a control unit in Example 2.

FIG. 9 is a waveform diagram (lower diagram) illustrating a temporal change of an output current of a DC/AC converter in Example 2.

FIG. 10 is a circuit diagram illustrating a configuration of a power conversion device that is Example 3.

FIG. 11 is a waveform diagram (lower diagram) illustrating a temporal change of an output current of a DC/AC converter in Example 3.

### DESCRIPTION OF EMBODIMENTS

Hereinafter, an embodiment of the present invention will be described according to Examples 1 to 3 below with reference to the drawings.

In the drawings, the same reference signs indicate the same components or components having similar functions.

### Example 1

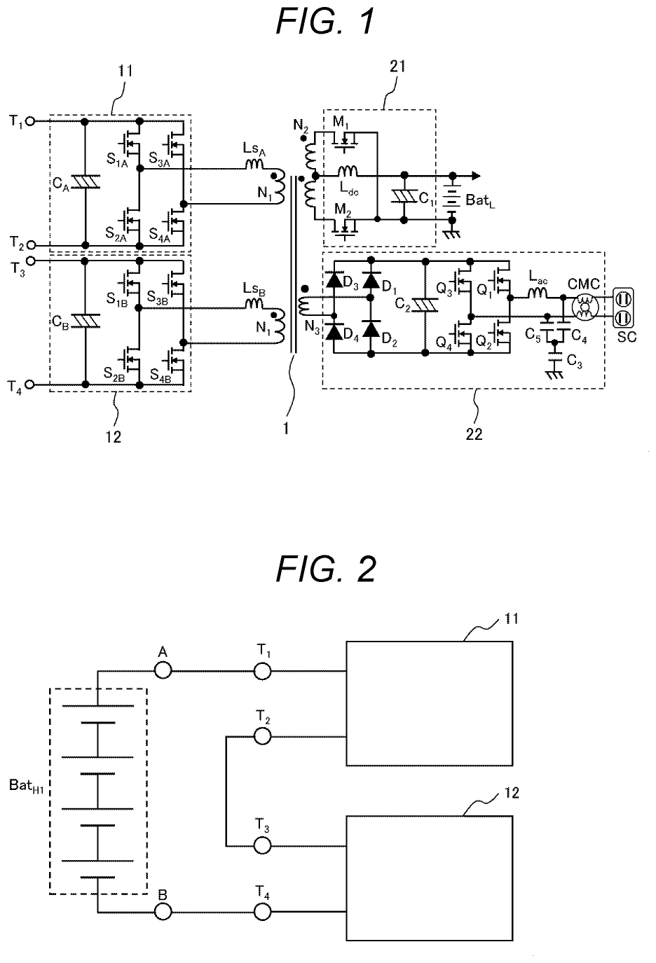

FIG. 1 is a circuit diagram illustrating a configuration of a power conversion device that is Example 1 of the present invention.

As illustrated in FIG. 1, the power conversion device of Example 1 includes a multi-winding transformer 1 including a plurality of windings (four windings in FIG. 1) and a plurality of power converters (11, 12, 21, and 22) connected to the plurality of windings. Note that the power conversion device is mounted on an electric vehicle (not illustrated).

In the multi-winding transformer 1, four independent windings are wound around one magnetic core.

AC sides of the DC/AC converters 11 and 12 (inverters) are connected to two primary-side windings N₁, respectively. The DC/AC converter 11 includes DC voltage input terminals T₁ and T₂ on a DC side. The DC/AC converter 12 includes DC voltage input terminals T₃ and T₄ on the DC side. As described later, a main battery is connected to the DC/AC converters 11 and 12 at the DC voltage input terminals Ti to T₄. Note that the main battery supplies electric power for driving an electric motor (main machine) that is a power source of the electric vehicle.

In the DC/AC converter 11, semiconductor switching elements S_{1A}, S_{2A}, S_{3A}, and S_{4A} constitute a single-phase full-bridge circuit. This single-phase full-bridge circuit operates as a DC/AC conversion circuit (inverter circuit). AC outputs of the DC/AC conversion circuit are connected to one of the two primary-side windings N₁. DC inputs of the DC/AC conversion circuit are connected to the DC voltage input terminals T₁ and T₂. An electrolytic capacitor CA is connected to the DC inputs of the DC/AC conversion circuit. That is, the electrolytic capacitor CA is connected between the DC voltage input terminals T₁ and T₂.

In Example 1, a power MOSFET is applied as the semiconductor switching elements S_{1A}, S_{2A}, S_{3A}, and S_{4A}. A body diode of the MOSFET is used as a reflux diode.

In the DC/AC converter 12, semiconductor switching elements S_{1B}, S_{2B}, S_{3B}, and S_{4B} constitute a single-phase full-bridge circuit. This single-phase full-bridge circuit operates as a DC/AC conversion circuit (inverter circuit). AC outputs of the DC/AC conversion circuit are connected to the other of the two primary-side windings N₁. DC inputs of the DC/AC conversion circuit are connected to the DC voltage input terminals T₃ and T₄. An electrolytic capacitor CB is connected to the DC inputs of the DC/AC conversion circuit. That is, the electrolytic capacitor CB is connected between the DC voltage input terminals T₃ and T₄.

In Example 1, a power MOSFET is applied as the semiconductor switching elements S_{1B}, S_{2B}, S_{3B}, and S_{4B}. A body diode of the MOSFET is used as a reflux diode.

The DC/AC converter 11 performs on/off control of the semiconductor switching elements S_{1A}, S_{2A}, S_{3A}, and S_{4A} by a gate drive circuit (not illustrated) to convert a DC voltage output from the main battery input from the DC voltage input terminals T₁ and T₂ into an AC voltage, and outputs the AC voltage to one of the two primary-side windings N₁.

The DC/AC converter 12 performs on/off control of the semiconductor switching elements S_{1B}, S_{2B}, S_{3B}, and S_{4B} by a gate drive circuit (not illustrated) to convert a DC voltage output from the main battery input from the DC voltage input terminals T₃ and T₄ into an AC voltage, and outputs the AC voltage to the other of the two primary-side windings N₁.

The AC voltages output from the DC/AC converters 11 and 12 to the two primary-side windings N₁ are stepped down by the multi-winding transformer 1. The stepped-down AC voltages are output from secondary-side windings N₂ and N₃of the multi-winding transformer 1.

An AC/DC converter 21 (rectifier) is connected to the secondary-side winding N₂. The AC/DC converter 21 includes a synchronous rectifier circuit including MOSFETs M₁ and M₂, and a smoothing circuit including a DC reactor Lac and a capacitor C₁. The AC voltage output from the secondary-side winding N₂ is rectified by the synchronous rectifier circuit and further smoothed by the smoothing circuit. As a result, the AC/DC converter 21 outputs a DC voltage lower in voltage than the output voltage of the main battery. A low-voltage battery Bat_{L} is charged by the DC voltage output from the AC/DC converter 21.

The low-voltage battery Bat_{L} is a power source for in-vehicle electrical equipment (auxiliary machine) having a lower voltage than the electric motor.

An AC/AC converter 22 is connected to the secondary-side winding N₃. The AC/AC converter 22 includes a full-bridge rectifier circuit including diodes D₁ to D₄, a smoothing capacitor C₂, and a single-phase full-bridge circuit (inverter circuit) including MOSFETS Q₁ to Q₄.

An AC voltage output from the secondary-side winding N₃ is rectified by the full-bridge rectifier circuit. A full-wave rectified voltage output from the full-bridge rectifier circuit is smoothed by the smoothing capacitor C₂, and is input to the single-phase full-bridge circuit (inverter circuit) as a DC voltage. The single-phase full-bridge circuit (inverter circuit) converts the input DC voltage into an AC voltage by performing on/off control of the MOSFETs Q₁ to Q₄.

The AC output of the single-phase full-bridge circuit (inverter circuit) is connected to an in-vehicle outlet SC via an AC reactor L_{ac} and a capacitor filter circuit (C₃ to C₅) that suppress harmonics, and a common mode choke coil CMC that removes noise. As a result, a commercial voltage is obtained from the in-vehicle outlet sc. Therefore, electric equipment that operates at the commercial voltage can be used in the vehicle.

Note that a drive signal (gate signal) of the semiconductor switching elements (S_{1A} to S_{4A}, S_{1B} to S_{4B}) is generated by a control unit not illustrated so that the magnitudes of the AC voltages output from the DC/AC converters 11 and 12 become the same.

FIG. 2 is a circuit diagram illustrating a first connection form of the main battery on the DC side of the DC/AC converters 11 and 12 (FIG. 1). Note that, assuming that a withstand voltage of the semiconductor switching elements (S_{1A} to S_{4A}, S_{1B} to S_{4B}) is V_{DSS}, an output voltage V_{H1} of the main battery Bat_{H1} is larger than V_{DSS}.

For example, V_{H1} is 800 V and Voss is 650 V to 700 V.

Note that, in Example 1 (FIG. 1), the capacitances of the capacitors C_{A} and C_{B} are equal to each other. Therefore, DC voltages input to the DC/AC converters 11 and 12 are V_{H1}/(the number of DC/AC conversion circuits), that is, V_{H1}/2, which is equal to each other. Thus, V_{DSS} is larger than V_{H1}/2.

Among the DC voltage input terminals T₁ and T₂ of the DC/AC converter 11, T₁ on a high potential side is electrically connected to a positive electrode terminal A of the main battery Bat_{H1}. T₂ on a low potential side is electrically connected to T₃ on the high potential side among the DC voltage input terminals T₃ and T₄ of the DC/AC converter 12. T₄ on the low potential side is electrically connected to a negative electrode terminal B of the main battery Bat_{H1}.

Therefore, as illustrated in FIG. 2, in the first connection form, the DC inputs of the DC/AC converters 11 and 12 are connected in series, and both ends of the series connection are connected to the main battery Bat_{H1}. As a result, the power conversion device of Example 1 can be applied in a case where the output voltage of the main battery is larger than the withstand voltage of the semiconductor switching elements.

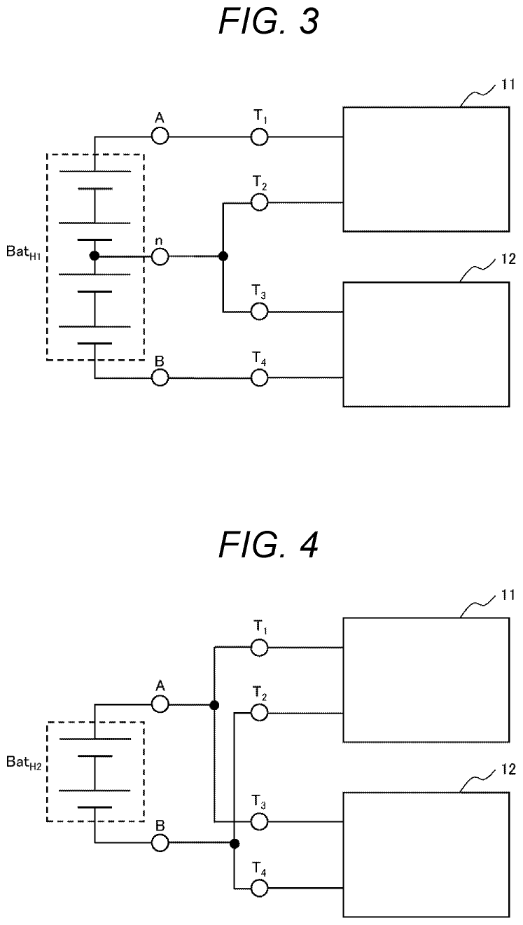

FIG. 3 is a circuit diagram illustrating a second connection form of the main battery on the DC side of the DC/AC converters 11 and 12 (FIG. 1).

Similarly to the first connection form (FIG. 2), the output voltage V_{H1} of the main battery Bat_{H1} is larger than the withstand voltage V_{DSS} of the semiconductor switching elements (S_{1A} to S_{4A}, S_{1B} to S_{4B}), and V_{DSS} is larger than V_{H1}/2 (V_{H1}>V_{DSS}>V_{H1}/2).

Differences from the first connection form (FIG. 2) will be described below.

As illustrated in FIG. 3, the main battery Bat_{H1} includes an intermediate potential terminal n. As in the first connection form (FIG. 2), the DC voltage input terminal T₂ of the DC/AC converter 11 and the DC voltage input terminal T₃ of the DC/AC converter 12 are electrically connected. In the second connection form (FIG. 3), T₂ and T₃ are further electrically connected to the intermediate potential terminal n of the main battery Bat_{H1}. As a result, the DC input voltages of the DC/AC converters 11 and 12 are balanced.

As a result, the power conversion device of Example 1 can be applied in a case where the output voltage of the main battery is larger than the withstand voltage of the semiconductor switching elements.

FIG. 4 is a circuit diagram illustrating a third connection form of the main battery on the DC side of the DC/AC converters 11 and 12 (FIG. 1).

The output voltage V_{H2} of the main battery Bat_{H2} is smaller than the output voltage V_{H2} of the main battery Bat_{H1} (FIG. 3). The withstand voltage V_{DSS} of the semiconductor switching elements (S_{1A} to S_{4A}, S_{1B} to S_{4B}) is larger than V_{H2}. That is, V_{H1}>V_{DSS}>V_{H2}.

For example, V_{H1} and V_{H2} are 800 V and 400 V, respectively, and V_{DSS} is 650 V to 700 V.

Among the DC voltage input terminals T₁ and T₂ of the DC/AC converter 11, T₁ on the high potential side is electrically connected to T₃ on the high potential side among the DC voltage input terminals T₃ and T₄ of the DC/AC converter 12. Moreover, T₁ and T₃ are electrically connected to the positive electrode terminal A of the main battery Bat_{H2}.

Among the DC voltage input terminals T₁ and T₂ of the DC/AC converter 11, T₂ on the low potential side is electrically connected to T₄ on the low potential side among the DC voltage input terminals T₃ and T₄ of the DC/AC converter 12. Moreover, T₂ and T₄ are electrically connected to the negative electrode terminal B of the main battery Bat_{H2}.

Therefore, as illustrated in FIG. 4, in the third connection form, the DC inputs of the DC/AC converters 11 and 12 are connected in parallel, and both ends of the parallel connection are connected to the main battery Bat_{H2}.

As a result, the power conversion device of Example 1 can be applied in a case where the output voltage of the main battery is smaller than the withstand voltage of the semiconductor switching elements.

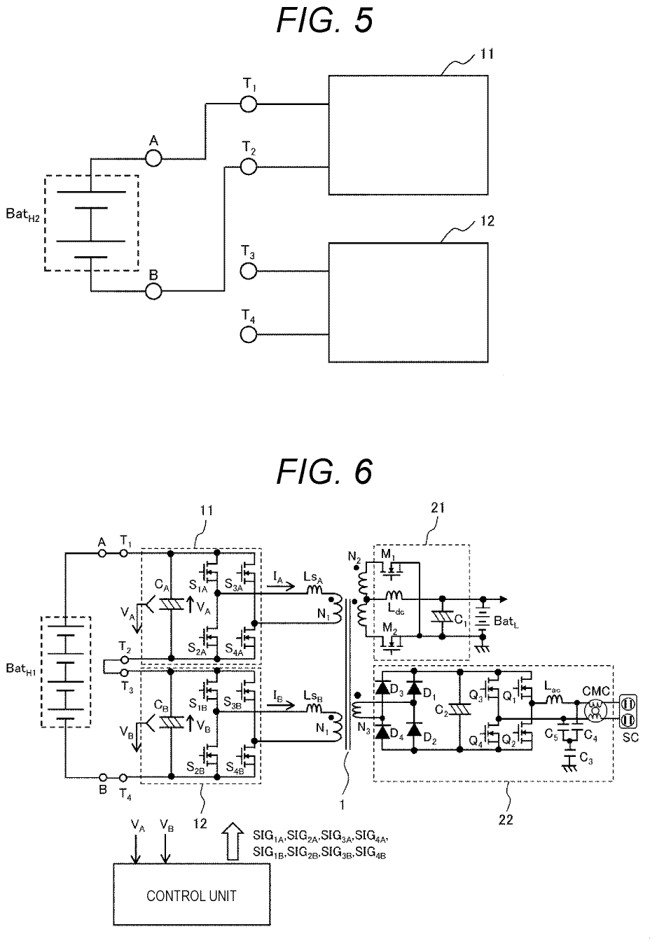

FIG. 5 is a circuit diagram illustrating a fourth connection form of the main battery on the DC side of the DC/AC converters 11 and 12 (FIG. 1).

The output voltage V_{H2} of the main battery Bat_{H2} is smaller than the output voltage V_{H1} of the main battery Bat_{H1} (FIG. 3). The withstand voltage V_{DSS} of the semiconductor switching elements (S_{1A} to S_{4A}, S_{1B} to S_{4B}) is larger than V_{H2}.

Similarly to the third connection form (FIG. 4), the output voltage V_{H2} of the main battery Bat_{H2} is smaller than the output voltage V_{H1} of the main battery Bat_{H1} (FIG. 3), and the withstand voltage V_{DSS} of the semiconductor switching elements (S_{1A} to S_{4A}, S_{1B} to S_{4B}) is larger than V_{H2}.

As illustrated in FIG. 5, in the fourth connection form, the DC input terminals (T₁ and T₂ in FIG. 5) in only one (the DC/AC converter 11 in FIG. 5) of the DC/AC converters 11 and 12 are electrically connected to the main battery Bath_{H2}.

As a result, the power conversion device of Example 1 can be applied in a case where the output voltage of the main battery is smaller than the withstand voltage of the semiconductor switching elements. Note that one of the third and fourth connection forms is used according to the power supplied by the power converter connected to the secondary-side winding of the multi-winding transformer 1.

As described above, according to Example 1, the power conversion device can be shared by main batteries having different output voltages.

Note that the numbers of primary-side windings of the multi-winding transformer 1, and DC/AC converters connected to the primary-side winding may be two or more.

### Example 2

As described below, a power conversion device of Example 2 includes means for suppressing a cross current between a plurality of the DC/AC converters connected to a plurality of the primary-side windings of the multi-winding transformer 1.

FIG. 6 is a circuit diagram illustrating a configuration of a power conversion device that is Example 2 of the present invention.

Hereinafter, differences from Example 1 will be described.

In Example 2, the first connection form illustrated in FIG. 2 is used as a connection form of the main battery on the DC side of the DC/AC converters 11 and 12 (FIG. 1).

A main circuit configuration including the multi-winding transformer 1, the DC/AC converters 11 and 12, the AC/DC converter 21, and the AC/AC converter 22 is similar to that of Example 1 (FIG. 1).

When there is a phase difference between the AC voltages output from the DC/AC converters 11 and 12 to the primary-side windings N₁, power is transmitted between the DC/AC converters 11 and 12 via the multi-winding transformer 1, and an imbalance of the output currents I_{A} and I_{B}, that is, a cross current occurs. Such a phase difference may occur in a case where there are variations in the switching characteristics of the semiconductor switching elements, the magnitude of the wiring inductance (for example, Ls_{A} and Ls_{B}), and the like between the DC/AC converters 11 and 12.

Therefore, in Example 2, the on/off drive of the semiconductor switching element (S_{1A} to S_{4A}, S_{1B} to S_{4B}) is controlled to reduce the phase difference of the AC voltages output from the DC/AC converters 11 and 12 to each of the primary-side windings N₁, thereby suppressing the cross current.

The control unit illustrated in FIG. 6 generates drive signals (SIG_{1A} to SIG_{4A}, SIG_{1B} to SIG_{4B}) of the semiconductor switching elements (S_{1A} to S_{4A}, S_{1B} to S_{4B}) so that the magnitudes of the AC voltages output from the DC/AC converters 11 and 12 become the same. Furthermore, the control unit generates drive signals (SIG_{1A} to SIG_{4A}, SIG_{1B} to SIG_{4B}) on the basis of detected values of a voltage Va of the capacitor C_{A} and a voltage V_{B} of the capacitor C_{B} so as to reduce the phase difference of the AC voltages output from the DC/AC converters 11 and 12.

When an imbalance occurs in I_{A} and I_{B}, an imbalance also occurs in V_{A} and V_{B}. Therefore, the control unit in Example 2 controls the on/off drive of the semiconductor switching elements (S_{1A} to S_{4A}, S_{1B} to S_{4B}) on the basis of V_{A} and V_{B} that can be relatively easily detected so as to reduce the phase difference of the AC voltages output from the DC/AC converters 11 and 12.

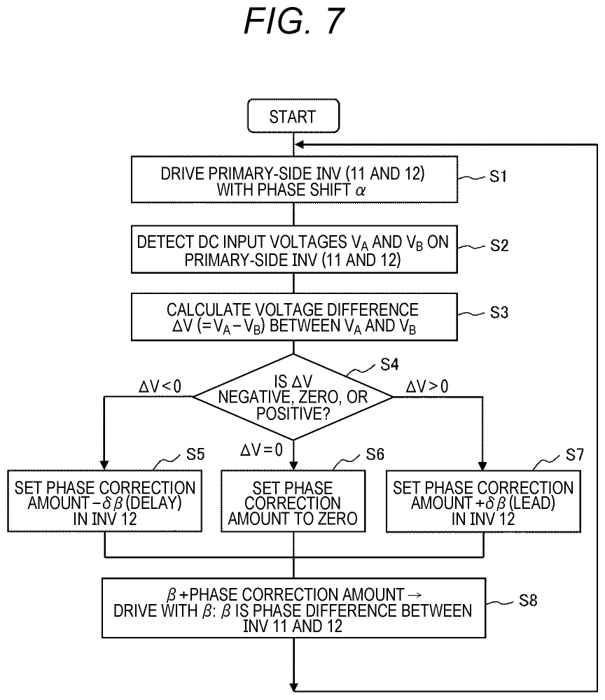

FIG. 7 is a flowchart illustrating the operation of the control unit in Example 2. Note that FIG. 6 is appropriately referred to.

Note that, in Example 2, the control unit includes a computer system such as a microcomputer, and controls the DC/AC converters 11 and 12 by executing a predetermined program by the computer system.

In step S1, the control unit drives the DC/AC converters 11 and 12, that is, the inverter (Hereinafter, it is referred to as a “primary-side INV” .) on the primary side of the multi-winding transformer 1 by a so-called phase shift method.

A phase shift α is provided between a set of S_{1A} and S_{2A} and a set of S_{3A} and S_{4A} in the DC/AC converter 11. The same phase shift α is provided between a set of S_{1B} and S_{2B} and a set of S_{3B} and S_{4B} in the DC/AC converter 12. Both the DC/AC converters 11 and 12 output AC voltages of the same magnitude by setting the same phase shift α.

Note that S_{1A} and S_{2A} are complementarily turned on and off. Similarly, S_{3A} and S_{4A}, S_{1B} and S_{2B}, and S_{3B} and S_{4B} are complementarily turned on and off.

Next, in step S2, the control unit detects a DC input voltage to the single-phase full-bridge circuit on the primary-side INV, that is, the voltage V_{A} of the capacitor C_{A} and the voltage V_{B} of the capacitor C_{B}.

Next, in step S3, the control unit calculates a voltage difference ΔV (=V_{A}−V_{B}) between V_{A} and the voltage V_{B}.

Next, in step S4, the control unit determines whether the value of ΔV calculated in step S3 is negative, zero, or positive. When determining as negative (ΔV<0), zero (≢V=0) and positive (ΔV>0), the control unit executes step S5, step S6, and step S7, respectively.

In step S5, the control unit sets a delay phase correction amount −δβ in the INV 12 (DC/AC converter 12).

In the case of ΔV<0 (V_{A}<V_{B}), power is being transmitted from the INV 11 (DC/AC converter 11) to the INV 12 (DC/AC converter 12). That is, a cross current occurs between the INV 11 (DC/AC converter 11) and the INV 12 (DC/AC converter 12). At this time, the phase of the AC output voltage of the INV 12 (DC/AC converter 12) is advanced with respect to the AC output voltage of the INV 11 (DC/AC converter 11). Therefore, by setting the delay phase correction amount −δβ in the INV 12 (DC/AC converter 12) to reduce a phase difference β between the AC output voltage of the INV 11 (DC/AC converter 11) and the AC output voltage of the INV 12 (DC/AC converter 11), the cross current can be suppressed.

In step S6, the control unit sets a phase correction amount of the INV 12 (DC/AC converter 12) to zero.

In the case of ΔV=0, since no cross current occurs, it is not necessary to correct the phase difference β between the AC output voltage of the INV 12 (DC/AC converter 12) and the AC output voltage of the INV 11 (DC/AC converter 11), so that the phase correction amount of the INV 12 (DC/AC converter 12) is set to zero.

In step S7, the control unit sets a lead phase correction amount +δβ in the INV 12 (DC/AC converter 12).

In the case of ΔV>0 (V_{A}>V_{B}), power is being transmitted from the INV 12 (DC/AC converter 12) to the INV 11 (DC/AC converter 11). That is, a cross current occurs between the INV 11 (DC/AC converter 11) and the INV 12 (DC/AC converter 12). At this time, the phase of the AC output voltage of the INV 11 (DC/AC converter 11) is advanced with respect to the AC output voltage of the INV 12 (DC/AC converter 12). That is, the AC output voltage of the INV 12 (DC/AC converter 12) is delayed in phase with respect to the AC output voltage of the INV 11 (DC/AC converter 11). Therefore, by setting the lead phase correction amount +δβ in the INV 12 (DC/AC converter 12) to reduce the phase difference β between the AC output voltage of the INV 11 (DC/AC converter 11) and the AC output voltage of the INV 12 (DC/AC converter 11), the cross current can be suppressed.

Note that, in steps S5 to S7, the control unit calculates the phase correction amount by, for example, a proportional-integral (PI) control unit according to ΔV.

After executing any of steps S5, S6, and S7, the control unit then executes step S8.

In step S8, the control unit generates drive signals (SIG_{1A} to SIG_{4A}, SIG_{1B} to SIG_{4B}) on the basis of the phase difference β corrected by the set phase correction amount, and drives the semiconductor switching elements (S_{1A} to S_{4A}, S_{1B} to S_{4B}) in the INV 11 (DC/AC converters 11 and 12) by the generated drive signals.

The control unit 8 sets a phase difference between SIG_{nA} and SIG_{nB} (n=1, 2, 3, and 4) so as to reduce the phase difference β on the basis of the corrected phase difference 3. That is, the control unit 8 compensates for the phase shift between the AC output voltage of the INV 11 (DC/AC converter 11) and the AC output voltage of the INV 12 (DC/AC converter 11) by shifting switching timings of the semiconductor switching element S_{nA} in the INV 11 (DC/AC converter 11) and the semiconductor switching element S_{nB} in the INV 12 (DC/AC converter 12) (n=1, 2, 3, and 4).

The control unit repeatedly executes steps S1 to S8 while the power conversion device is operating.

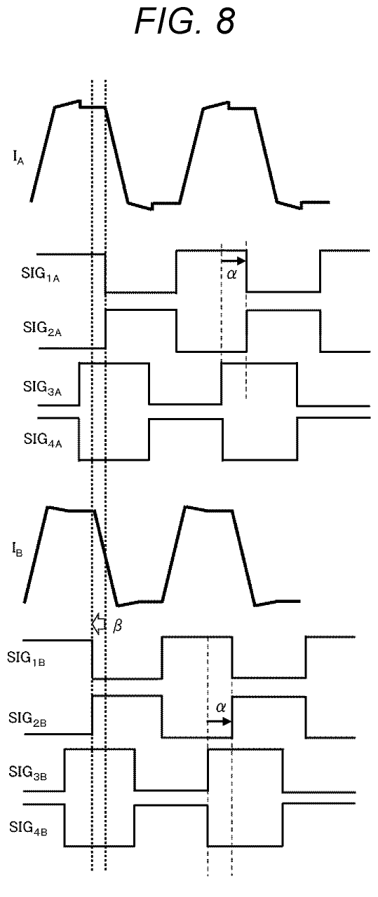

FIG. 8 is a timing chart illustrating on/off of the drive signals generated by the control unit in Example 2.

As illustrated by the output current I_{A} of the DC/AC converter 11 and the output current I_{B} of the DC/AC converter 12 described also in FIG. 8, the phase difference β occurs between I_{A} and I_{B} due to the phase difference β between the AC output voltage of the DC/AC converter 11 and the AC output voltage of the DC/AC converter 12. Moreover, as the cross current occurs, an imbalance occurs between I_{A} and I_{B}.

In order to reduce the phase difference β, the control unit generates the drive signals (SIG_{1A} to SIG_{4A}, SIG_{1B} to SIG_{4B}) as illustrated in FIG. 8. That is, the control unit sets the phase difference β between SIG_{nA} and SIG_{nB} (n=1, 2, 3, and 4). Since the control unit sequentially sets the corrected β, the cross current is suppressed with high accuracy.

Note that a phase difference α illustrated in FIG. 8 corresponds to the phase shift α in the phase shift control (step S1 in FIG. 7) in each DC/AC converter.

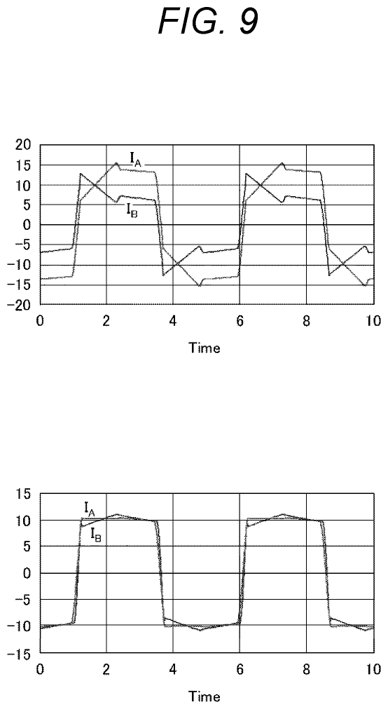

FIG. 9 is a waveform diagram (lower diagram) illustrating temporal changes of the output currents I_{A} and I_{B} of the DC/AC converters 11 and 12 in Example 2. In addition, a waveform diagram (upper diagram) of I_{A} and I_{B} in a case where a cross current occurs is illustrated.

As illustrated in FIG. 9, according to the Example 2, the magnitudes of I_{A} and I_{B} are balanced, and the phases of I_{A} and I_{B} are aligned.

As described above, according to Example 2, the cross current generated between the plurality of DC/AC converters 11 and 12 connected to the primary side of the multi-winding transformer 1 is suppressed. Therefore, the efficiency of the power conversion device according to Example 1 is improved.

Note that the control unit in Example 2 can also be applied to a case where a connection form of the main battery is the second and third connection forms (FIGS. 3 and 4).

### Example 3

As described below, the power conversion device of Example 3 includes means for suppressing a cross current between the plurality of DC/AC converters connected to the plurality of primary-side windings of the multi-winding transformer 1.

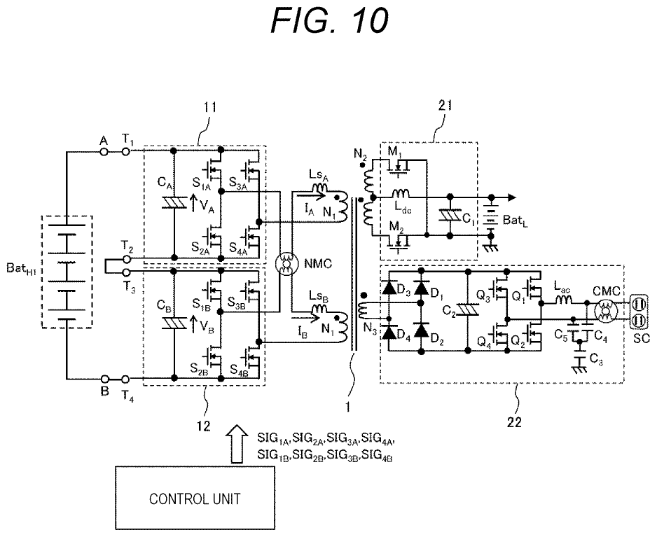

FIG. 10 is a circuit diagram illustrating a configuration of a power conversion device that is Example 3 of the present invention.

Hereinafter, differences from Example 2 (FIG. 6) will be described.

In Example 3, a normal mode choke coil is used as means for suppressing the cross current. Therefore, the control unit executes only the phase shift control of step S1 among steps S1 to S8 illustrated in FIG. 7.

In the normal mode choke coil NMC in Example 3, two windings are wound around a ring-shaped magnetic core having no air gap. One of the windings is electrically connected between one AC output of the DC/AC converter 11 and one end of the primary winding N₁ to which the AC output of the DC/AC converter 11 is connected. The other of the windings is electrically connected between one AC output of the DC/AC converter 12 and one end of the primary winding N₁ to which the AC output of the DC/AC converter 12 is connected.

A direction of the output current I_{A} (fundamental wave component) flowing through a wiring between the DC/AC converter 11 and the primary winding N₁ into which one winding of the NMC is inserted and a direction of the output current I_{B} (fundamental wave component) flowing through a wiring between the DC/AC converter 12 and the primary winding N₁ into which one winding of the NMC is inserted are the same direction. As described above, when the current flows in the same direction in each winding, each winding is wound around the magnetic core so that magnetic fluxes caused by the current flowing in each winding cancel each other. Therefore, the NMC does not act as an inductor with respect to the fundamental wave components of I_{A} and I_{B}.

On the other hand, I_{A} and I_{B} cross current components flow in directions opposite to each other in the two windings of the NMC. Therefore, since the magnetic fluxes caused by the currents flowing through the respective windings intensify each other, the NMC acts as an inductor. Accordingly, the cross current is suppressed.

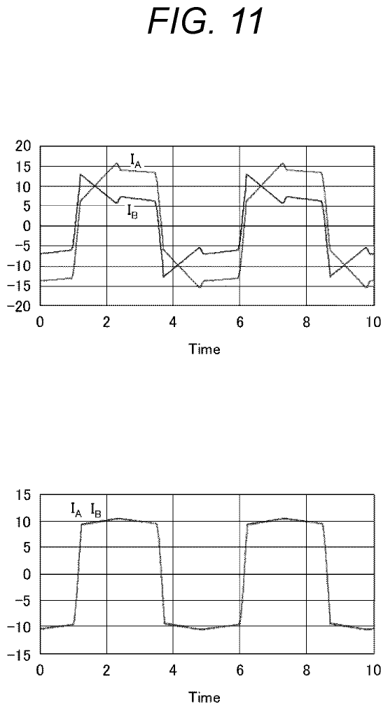

FIG. 11 is a waveform diagram (lower diagram) illustrating temporal changes of the output currents I_{A} and I_{B} of the DC/AC converters 11 and 12 in Example 3. In addition, a waveform diagram (upper diagram) of I_{A} and I_{B} in a case where a cross current occurs is illustrated.

As illustrated in FIG. 11, according to Example 3, the magnitudes of I_{A} and I_{B} are balanced, and the phases of I_{A} and I_{B} are aligned.

As described above, according to Example 3, the cross current generated between the plurality of DC/AC converters 11 and 12 connected to the primary side of the multi-winding transformer 1 is suppressed. Therefore, the efficiency of the power conversion device according to Example 1 is improved.

Note that the NMC in Example 3 can also be applied to a case where a connection form of the main battery is the second and third connection forms (FIGS. 3 and 4).

Note that the present invention is not limited to the above-described examples, and includes various modifications. For example, the above-described examples have been described in detail for easy understanding of the present invention, and are not necessarily limited to those having all the described configurations. Furthermore, with regard to a part of the configurations of each example, it can be deleted, another configuration can be added, or another configuration can be replaced.

For example, the semiconductor switching elements in the DC/AC converters 11 and 12 are not limited to the MOSFETs, and may be other semiconductor switching elements such as an insulated gate bipolar transistor or a junction bipolar transistor.

Moreover, the power conversion devices of Examples 1 to 3 may be applied not only to an electric vehicle but also to an electric moving body such as an electric ship and an electric aircraft.

### REFERENCE SIGNS LIST

1 multi-winding transformer
11 DC/AC converter
12 DC/AC converter
21 AC/DC converter
22 AC/AC converter

1. A power conversion device that converts an output voltage of a battery into an AC voltage or a DC voltage lower in voltage than the output voltage of the battery, the power conversion device comprising:
a multi-winding transformer including a plurality of windings, the plurality of windings including a first primary-side winding, a second primary-side winding, and a secondary-side winding;
a first DC/AC converter having a DC side and an AC side connected to the battery and the first primary-side winding, respectively;
a second DC/AC converter having a DC side and an AC side connected to the battery and the second primary-side winding, respectively; and
a power converter that converts an AC voltage output from the secondary-side winding into an AC voltage or a DC voltage lower in voltage than an output voltage of the battery,
wherein in a case where an output voltage of the battery is larger than a withstand voltage of a plurality of semiconductor switching elements in the first DC/AC converter and the second DC/AC converter,
respective DC inputs of the first DC/AC converter and the second DC/AC converter are connected in series to each other, and both ends of the DC inputs connected in series are connected to the battery, and
in a case where the output voltage of the battery is smaller than the withstand voltage,
the respective DC inputs of the first DC/AC converter and the second DC/AC converter are connected in parallel to each other, and both ends of the DC inputs connected in parallel are connected to the battery, or
only one of the DC inputs of the first DC/AC converter and the DC inputs of the second DC/AC converter is connected to the battery.

2. The power conversion device according to claim 1, wherein
in a case where the output voltage of the battery is higher than the withstand voltage, the withstand voltage is larger than ½ of the output voltage.

3. The power conversion device according to claim 1, wherein
in a case where the output voltage of the battery is higher than the withstand voltage, an intermediate potential of the battery is connected to a series connection point of the DC inputs connected in series.

4. The power conversion device according to claim 1, wherein
the power converter includes an AC/DC converter that charges a low-voltage battery having an output voltage lower than an output voltage of the battery.

5. The power conversion device according to claim 1, wherein
the power converter includes an AC/AC converter that outputs a commercial AC voltage.

6. The power conversion device according to claim 1, further comprising
a control unit that generates a drive signal of the plurality of semiconductor switching elements to suppress a cross current between the first DC/AC converter and the second DC/AC converter.

7. The power conversion device according to claim 6, wherein
the control unit sets a phase difference between the drive signal of the semiconductor switching elements in the first DC/AC converter and the drive signal of the semiconductor switching elements in the second DC/AC converter according to a voltage difference between a DC input voltage to a main circuit of the first DC/AC converter and a DC input voltage to a main circuit of the second DC/AC converter.

8. The power conversion device according to claim 1, further comprising
a normal mode choke coil connected between the first DC/AC converter and the first primary-side winding and between the second DC/AC converter and the second primary-side winding.
